(19) United States
(12) Patent Application Publication
(10) Pub. No.: US 2002/0029092 A1
(43) Pub. Date: Mar. 7, 2002

(54) Process tool and process system for processing a workpiece

(76) Inventor: Baltes Gass, Aalen (DE)

Correspondence Address: SUGHRUE, MION, ZINN, MACPEAK & SEAS, PLLC, 2100 PENNSYLVANIA AVENUE, N.W., WASHINGTON, DC, 20037-3213, US

(21) Appl. No.: 09/813,161

(22) Filed: Mar. 21, 2001

Related U.S. Application Data
(63) Continuation of application No. PCT/EP99/06961, filed on Sep. 21, 1999.

(30) Foreign Application Priority Data
Sep. 21, 1998 (DE) 198 43 151.1

(51) Int. Cl. G06F 19/00

(52) U.S. Cl. 700/116; 700/96; 700/9

(57) ABSTRACT

The inventive processing tool (4″) for processing a workpiece (5) comprises detecting device (4) for detecting workpiece-specific parameters and/or processing-specific parameters which are located on the workpiece (5, 5′). Said processing toll (4) and other processing tools (1-3) of a processing device are pre-set with the data that have been read. A processing operation can begin immediately after these data have been read, without the operator having a return to the processing tool pick-up device.

### FIELD OF THE INVENTION

The present invention relates to a process tool for processing a workpiece and a process system for processing a workpiece with programmed process parameters. The process tool and the process system are provided more particularly for processing workpieces in industrial series production requiring implementation of a plurality of repetitive assembly operations, e.g. tightening nuts and bolts with the aid of manual or powered assembly tools necessitating compliance with specific assembly parameters, e.g. torque and/or torsion angle for tightening the nut or bolt.

### BACKGROUND OF THE INVENTION

FIG. 1 is an overview of a production line 6, for example in automobile production, on which a plurality of workpieces 5, for example vehicle bodies, are run successively on a conveyor belt 6. The process operations required at individual process sites 9 are undertaken in each process station 1 with a plurality of tools 1, 2, 3. Process tool 1, for example, is a poke nut runner, process tool 2, for example, is an offset nut runner and process tool 3 is, for example, a sander. Each process tool 1, 2, 3 comprises an assigned control unit 1′, 2′, 3′ which is controlled by a main control device or host controller 8. The host controller 8 defines the work schedule, the individual control units 1′, 2′, 3′ being communicated the assigned process parameters, number of process operations, etc to be implemented by each process tool. For example, the control units 1′, 2′ may comprise an adapter bush crib for the poke or offset nut runner and specify the tightening torque and/or torsion angle for each bolting operation, whereby the actual values of each process tool 1, 2 is sensed during the process step. Thus a programming means programs the process parameters for specific process sites 9 and an operator applies the tools 1, 2, 3 to the assigned process sites 9 and implements processing.

The process tools may be arranged on the tool bench 10 in a prescribed sequence or randomly. In this arrangement it is to be noted that FIG. 1 merely illustrates the starting condition, for example, at the start of the day. In automobile production, requiring, for example, engine block, door, wheel, etc. assembly to a vehicle body 5, the length of each process station (assembly station) 1 is several meters and also the spacing between each workpiece 5 and the location at which the tool bench 10 (or some other means of supporting the process tool) is arranged is a few meters.

### PRIOR ART

Although the operations on the workpieces 5 as shown in FIG. 1, e.g. assembly operations, need to be implemented on each workpiece basically in the same sequence, it may be that individual process parameters and/or the sequence of specific process operations differ from one workpiece to another. For example, a first workpiece 5 may be a US version of an automobile and the workpiece 5′ a EU version of the automobile. The US version requires, for example, torques and bolting different to those of the EU version. This is why the host controller 8 needs to control for each workpiece 5′ entering the process station 1 the setting means provided in the control units 1′, 2′, 3′ for setting the one or more process tools to specific process parameters 14. For this purpose, information typically specific to each workpiece 5′ and/or specific to process is provided in the form of a workpiece card 7′ which needs to be available in the control units for controlling the tools.

A scanner 4 provided separately, directly coupled to the host controller 8, is picked up by the operator at point A and moved to the workpiece 5′ to somehow read the information stored on the card 7′. For this purpose, use is made normally of an optical scanner for reading a bar code on the process card 7′.

To start with, reading the information 7′ results in a programmediting of the host controller and thus of the control units 1′, 2′, 3′, this requiring the operator to go to point A, then to point A′, after which the scanner 4 is returned to the supporting means 10. The operator then goes to point B or point C to pick up the first process tool 1 or 2 (as indicated by the arrows in FIG. 1).

In series production in which the workpieces 5, 5′ are moved at a programmed speed through the process station 1, predefined times are to be maintained to make for cost-effective production. This is why in prior art, automated process tools are available which are capable of automatically implementing a process operation in accordance with programmed reference values (for example, AUTO screw drivers, nut runners, etc).

It is with the aim of minimizing idle time in optimizing the production process that the assignee of the present invention has discovered a further problem hitherto overlooked, namely that of the host controller 8 or the individual control units 1′, 2′, 3′ each needing to be programmed every time with the relevant information on the process card 7′ by a separate scan with the aid of the separate scanner 4, i.e. involving an additional operation in moving from point A to point A′ and back to the supporting means 10. In addition, this is needed separately for each workpiece. It is this additional operation that increases production time substantially.

### OBJECT OF THE INVENTION

As explained above, minimizing idle time in production is vital to reducing the costs in series production. The problem as discovered by the assignee and forming the basis of the invention thus involves defining a process system permitting a time-optimized production process, more particularly a reduction in the time needed for programming the control units of tools.

### ACHIEVEMENT OF THE OBJECT

In accordance with the invention a process system for processing a workpiece with programmed process parameters is provided, whereby one or more tools comprise(s) a means for sensing parameters specific to the workpiece and/or to the process. The sensing means is able to read information, for example, information attached to the workpiece as regards the process parameters and the workpiece-specific parameters. Since the sensing means is part of the process tool, processing can now commence instantly on having sensed the parameters specific thereto without an operator having to return a separately provided scanner to the tool support, thus making for a considerable reduction in time on commencement of the operation.

### PREFERRED EMBODIMENTS OF THE INVENTION

The sensing means comprises preferably an optical scanner whereby the specific parameters are configured as a bar code. The operator thus needs merely to “shoot” the bar code.

The sensing means may be placed on the process tool or integrated in a housing of the process tool.

After the sensing means has sensed the relevant information, a setting means of the process system is able to set each process tool, i.e. not only the process tool with the sensing means, on the basis of the information sensed for processing.

The process-specific parameters comprise preferably a number of predefined operations for each process tool in each process step, and an enabling device is provided which enables one or more process tools for a subsequent step in the operation only when an operation sensing means “sees” that the predefined operations have been implemented in a previous step in the operation.

When the process tools are nut runners, the workpiece-specific parameters indicate the type of workpiece involved and the process-specific parameters are sets of bolting parameters for the one or more nut runners per step in the operation.

Further advantageous embodiments and improvements of the invention are set forth in the sub-claims. The invention will now be detained by way of its embodiments with reference to the drawings.

### BRIEF DESCRIPTION OF THE DRAWINGS

The following is illustrated in the drawings:

FIG. 1 is an overview of a process station 1 in industrial series production of workpieces 5, 5′;

FIG. 2 is an overview of a process station 1 including a process system comprising process tools in accordance with the invention; and

FIG. 3 is an illustration of one embodiment of a process tool including a mounted scanner.

### DESCRIPTION OF THE PREFERRED EMBODIMENTS

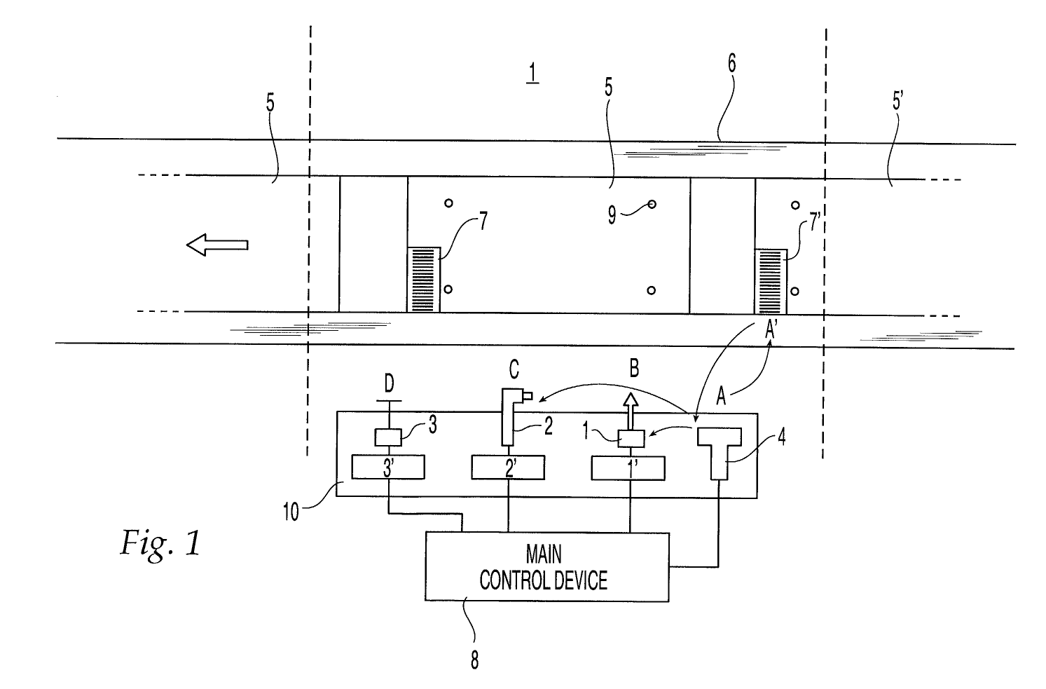

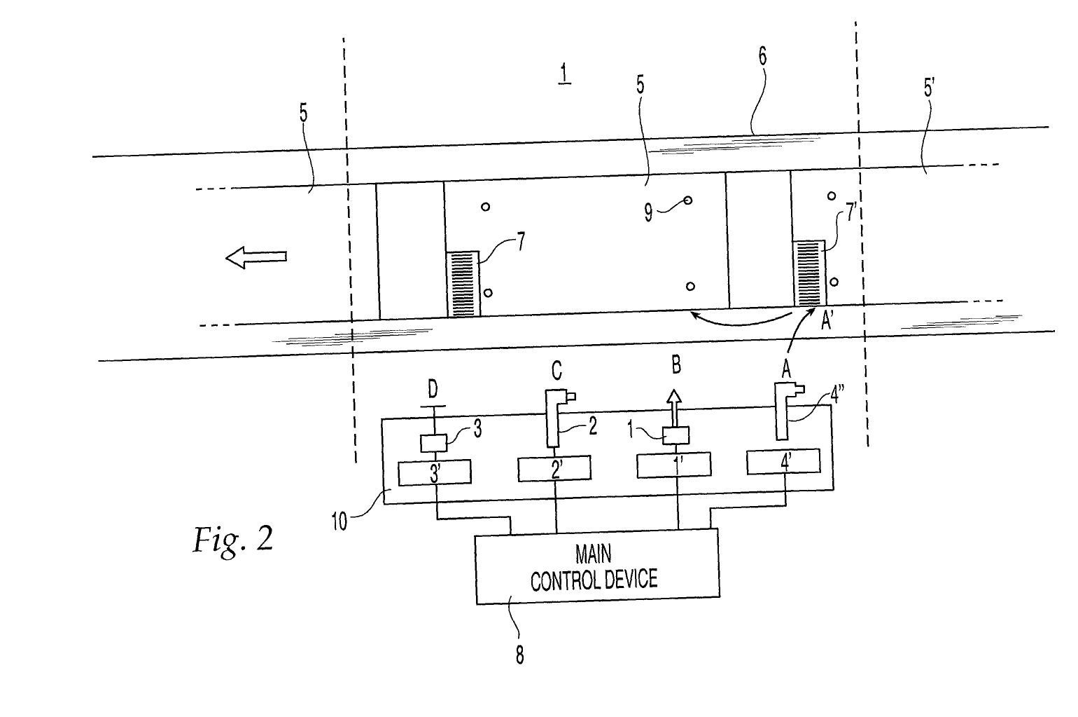

Referring now to FIG. 2 there is illustrated an overview of the process station 1, similar to that as shown in FIG. 1, showing a plurality of process tools 1-3, 4″, each assigned control units 1-4′. The same as in FIG. 1, these are located on a process tool bench (or a process tool support means) 10. The individual control units 1′-4′ are connected to the host controller 8. The system for processing a workpiece 5, 5′ with programmed process parameters comprises one or more process tools 1-3, 4″ as well as the individual control units 1′-4′. It is to be noted that the process tools 1-3, 4″ may also be directly connected to the host controller 8, of course.

As evident from FIG. 2 the process tool 4″, which in this case is located at point A, also comprises an assigned control unit 4′ so that this process tool 4″ too is fully functionable, just like the other process tools 1-3. In accordance with the invention the process tool 4″ comprises a sensing means 4 for sensing parameters 7 specific to the workpiece and/or to process, applied, for example, to the workpiece 5′ in the form of a process card 7.

When an operator moves the process tool 4″ with the sensing means 4 provided thereon from point A to point A′, each of the parameters 7′ can then be read by means of the sensing means 4, the process tool 4″ communicating the sensed parameters via the control unit 4′ to the host controller 8 which on the basis of the sensed parameters then instigates control of the individual control units 1′-4′ and thus of the individual process tools 1-3, 4″.

As indicated by the arrows in FIG. 2 an operator is now able to instantly commence a process operation with the process tool 4′ once the information has been read at point A′ (considering workpiece 5 as being the workpiece 5′ after a predefined time, since the workpieces are moved at a predefined speed through the process station 1).

Although in FIG. 2 only one process tool 4′ is provided with the sensing means 4, the process system may be configured so that all tools 1-3 comprise a sensing means 4 to thus ensure that a continuous operation can be commenced with each process tool directly after the parameters have been read. This thus makes sure that all and any work schedules as defined for the workpiece-specific parameters and/or the process-specific parameters can be implemented. Since the user is no longer required to return the process tool to its supporting means, after the parameters have been read, continuous operation is made possible, thus reducing idle time in production.

The process-specific parameters 7 sensed by the sensing means 4 comprise for each process tool a number of predefined operations, for example bolting operations (number of boltings) and an enabling means provided in either the host controller 8 or in the individual control units 1′-4′ enables each of the process tools for a further process step only when a means sensing the operations has “seen” that the predefined operations have been implemented in a previous step in the operation. This thus assures the process since it is not until the complete work schedule of one or more process tools has been executed that the following work process is enabled.

The process tools 1-4 may be nut runners 1, 2, the workpiece-specific parameters may indicate the type of workpiece involved, and the process-specific parameters may be sets of bolting parameters for the one or more nut runners for each step in the operation. As soon as the information has been read by the sensing means 4, the setting means in each control unit 1′-4′ undertakes setting the nut runners to the data of the sets of bolting parameters.

Various embodiments of the process tool including the sensing means are possible as will now be described. The parameters 7, 7′ to be sensed on the workpiece may be configured as a bar code and the sensing means 4 in this case may be a simple scanner, i.e. a bar code scanner, although, of course, other imaging means, for example a camera, may be used for the sensing means 4. The process tool may be provided with a light source (e.g. an infrared light source when the scanner is an infrared scanner) to illuminate a zone located ahead of the process tool to facilitate scanning the information parameters 7, 7′.

Other possibilities are likewise conceivable for the sensing means 4. For instance, the information (parameters) 7, 7′ may exist in the form of a signal which is sent from an emitter provided on the workpiece or at some other location in the process station 1, the sensing means 4 on the process tool then comprising a means for detecting this signal. Infrared systems for emitting/detecting the information in each case are an example for the communication systems used.

Preferably it is the process tool 4″ first picked up that reads the complete parameter sets for all tools 1-3, 4″ from the workpiece 5′, although it is just as possible that each process tool 1-3 comprises a sensing means 4 so that each process tool reads only the set of parameters provided in each case.

Scanning the parameters may be done automatically simply by the operator “shooting” the bar code. A switch may be provided for data scan verification. Furthermore, a display means may be provided on the process tool itself to display the scanned data along with verification thereof. It is not necessary that all parameters for the individual process operations of a single process tool are centralized in location as shown in FIG. 2, it being just as possible that a process bar code is provided at each process site 9. Then, the operator “shoots” the bar code provided there to instantly commence processing as soon as the enable has been given.

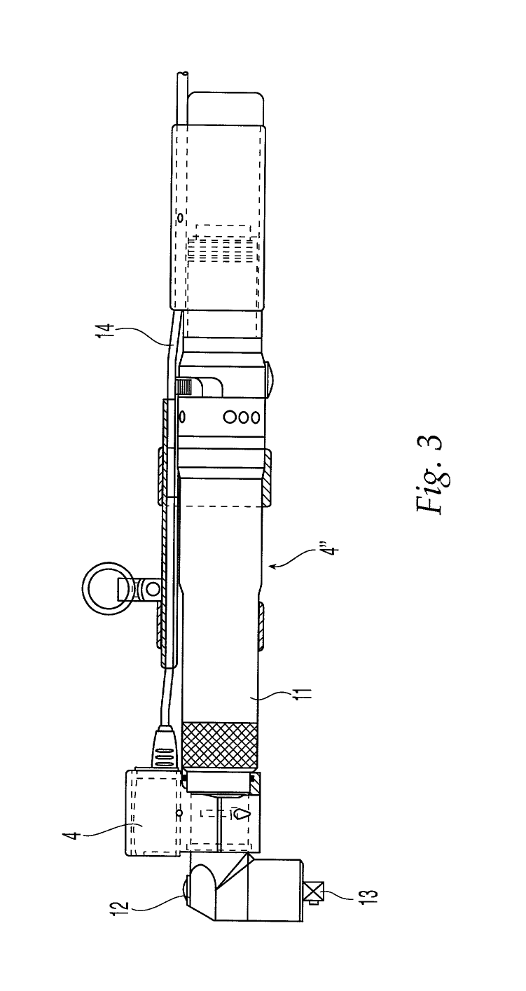

Referring now to FIG. 3 there is illustrated an embodiment of a process tool 4″ in accordance with the invention. The process tool (in this case an offset nut runner) comprises typically a housing 11, an offset gear 12 and a lug 13 for mounting the adapter bush. In FIG. 3 the sensing means 4 is mounted on the housing 11 of the process tool 4″ by means of a support and the sensed signals are communicated via a cable 14 to the control unit 4′. It is understood that mounting the sensing means 4 on the process tool is not restricted to an offset nut runner, i.e. any other process tool may be used.

In accordance with a further embodiment of the invention it is also possible, depending on the kind of sensing means 4 involved, to integrate the sensing means 4 in the housing 11 of the process tool. The data sensed by the sensing means 4 can be communicated via fiber-optic cable to the control unit 4′ or multiplexed on the control cable already provided between the process tool and the control unit. Thus, only a single cable is needed between process tool and control unit. Likewise possible is wireless communication directly to the control unit.

The sensing means 4 must not necessarily be mounted with the aid of a support on the process tool, it may also be bonded or screwed onto the process tool, so that the sensing means 4 can be applied optionally to one or more tools. As explained above, the process system may include a process tool including a sensing means 4 or several tools with sensing means 4 in addition to the other tools without sensing means 4.

### COMMERCIAL APPLICATION

Hitherto, the process system and the process tool in accordance with the invention have been described with reference to series production in automobile production. It is understood, however, that the invention is applicable to any kind of series production where it is necessary to set a number of tools to specific sets of parameters in assignment to each successively arriving workpiece. Thus, the operations and parameters involved in the process are not restricted to bolting with a specific torque and/or torsion angle in the sets of parameters. Instead, the specific parameters can be sensed in accordance with the requirements of the process operation.

It is understood that on the basis of the aspects, as described above, a wealth of modifications and changes to the invention are possible, without departing from the scope of the invention as defined by the attached claims and the above description of the embodiments. More particularly, the invention comprises features as set forth separately in the claims and in the description. Reference numerals in the claims merely serve for a better understanding and shall not be interpreted to restrict the scope of protection afforded by the following claims.

What is claimed is:

1. A process system (FIG. 2, 4″) comprising
a) at least one manually guided process tool (4″) including a mechanical process unit (12, 13) for mechanically processing a workpiece (5);
b) at least one host controller (1′, 2′, 3′, 4′;8) provided separate from said process tool (4″), connecting (14) said manually guided process tool (4″),
c) said host controller (1′, 2′, 3′, 4′;8) controlling a controller on said manually guided process tool (FIG. 2, 4″) on the basis of workpiece-specific processing parameters (7′) provided in said host controller;
characterized in that
d) said workpiece-specific process parameters (7′) are applied to a process card (7′) attached to said workpiece; and
e) said workpiece-specific process parameters (7′) provided in said host controller, on the basis of which said host controller undertakes control of said process tool, are sensed on said process tool (4″) itself with the aid of a sensing means (4) and communicated to said host controller; and
f) said sensing means (4) is an optical scanner for scanning said workpiece-specific process parameters on said workpiece and is mounted on said process tool (4″) in the vicinity of said mechanical process unit (13) on a housing (11) on said process tool (4″) or is integrated in said housing (11), whereby
g) said scanner (4) communicates said scanned workpiece-specific process parameters (7) to said host controller (1′, 2′, 3′, 4′) which then undertakes control of said process tool (4″) on the basis of said scanned and communicated workpiece-specific process parameters (7′).

2. The process system as set forth in claim 1, characterized in that a setting means (1′-4′) is provided for setting said one or more process tools (4″, 1′-3′) on the basis of said sensed parameters (7).

3. The process system as set forth in claim 1, characterized in that said scanner senses further process-specific parameters (7) and said process-specific parameters (7) define a number of predefined operations for each process tool (4″, 1-3) in each operational step and an enabling means (1′-4′) is provided which enables one or more process tools (4″, 1-3) for a subsequent operational step when an operation sensing means (1′-4′) “sees” that said predefined operations have been implemented in a previous operational step.

4. The process system as set forth in claim 2, characterized in that said one or more process tools (1-4) are nut runners (1, 2), said workpiece-specific parameters (7) indicate the type of workpiece and said process-specific parameters are sets of bolting parameters for said one or more nut runners (1, 2) per operational step, said setting means (1′, 2′) setting said nut runners (1, 2) in each operational step to the data on said sets of bolting parameters.

5. The process system as set forth in claim 1, characterized in that said parameters (7) to be sensed are configured as a bar code on said process card and said sensing means (4″) is a bar code reader.
